(19) United States
(12) Patent Application Publication
(10) Pub. No.: US 2019/0335888 A1
(43) Pub. Date: Nov. 7, 2019

(54) STEAM CLEANER FOR GRILL OVEN

(71) Applicant: Anvid Products, Inc., Livermore, CA (US)

(72) Inventor: Weiyuan Huang, Pleasanton, CA (US)

(21) Appl. No.: 16/023,344

(22) Filed: Jun. 29, 2018

(30) Foreign Application Priority Data
May 3, 2018 (CN) 201820665190.2

(51) Int. Cl. A46B 11/00; A47J 37/06; A46B 5/00; A46B 9/00; A46B 9/12

(52) U.S. Cl. CPC A46B 11/002; A47J 37/0664; A46B 9/12; A46B 9/005; A46B 5/0095

(57) ABSTRACT

A steam cleaner for grill oven, having a body, a steam generator disposed inside the body, and a cleaner head connected with the body; the cleaner head has a connector, a nozzle and a brush; the cleaner head is connected with the body through the connector; the nozzle and the brush are mounted on the connector; the nozzle is connected to the steam generator; steam generated by the steam generator is ejected through the nozzle; the nozzle is positioned above the brush; the steam ejected through the nozzle flows to the brush where the steam is condensed into water which is used for cleaning surfaces of the grill oven.

### BACKGROUND OF THE INVENTION

The present invention relates to the technical field of cleaning devices, and more specifically relates to a steam cleaner for grill oven.

A steam cleaning device is an electronic cleaning device that sterilizes and cleans dirty surfaces like floor surfaces, wall surfaces and table tops by using hot and pressurized steam produced by heating up water. Take a common steam mop as an example: when the steam mop is working, hot steam generated inside the mop is ejected through the mop head to wet the cleaning cloth wrapped on the mop head; when the floor is wiped by the cleaning cloth of the steam mop which the user manipulates, the floor is being cleaned. In general, a steam mop can only be used to clean planer surfaces like a floor surface. However, when cleaning oil and dirt in the kitchen, especially the oil and dirt of the grill oven, it is very difficult to clean thoroughly. A cleaning device which can clean a grill oven easily is not yet available in the market.

### BRIEF SUMMARY OF THE INVENTION

In view of the aforesaid disadvantages now present in the prior art, the present invention provides a steam cleaner for grill oven, which is structurally simple and compact, convenient to use, and easy to clean.

A steam cleaner for grill oven, comprising a body, a steam generator disposed inside the body, and a cleaner head connected with the body, wherein the cleaner head comprises a connector, a nozzle and a brush; the cleaner head is connected with the body through the connector; the nozzle and the brush are mounted on the connector; the nozzle is connected to the steam generator; steam generated by the steam generator is ejected through the nozzle; the nozzle is positioned above the brush; the steam ejected through the nozzle flows to the brush where the steam is condensed into water which is used for cleaning surfaces of the grill oven.

Preferably, in said steam cleaner for grill oven, the brush and the connector are removably connected to facilitate quick replacement of the brush by other kinds of brushes.

Preferably, in said steam cleaner for grill oven, the brush and the connector are connected via insertion, wherein the brush is inserted into the connector.

Preferably, in said steam cleaner for grill oven, the brush is a wire brush planted with steel wires on a brush surface thereof, or a wire ball brush which is a steel wire ball used for household cleaning, or a high-performance fiber brush.

Preferably, in said steam cleaner for grill oven, the brush comprises a pair of connecting rods, a pair of fixing rods and a pair of supporting rods connected with one another; top ends of the connecting rods are connected with the connector; the nozzle passes through between the supporting rods and situates above the fixing rods; the fixing rods are located at a bottom end of the brush; the fixing rods are provided with steel wires, or steel wire ball for household cleaning, or high-performance fibers.

Preferably, in said steam cleaner for grill oven, a hand-held portion is provided on the body; when using the steam cleaner to clean the grill oven, the hand-held portion is held by a user's hand.

Compared with prior arts, the present invention has the following beneficial effects: The steam cleaner of the present invention has a simple and scientific design, and a compact structure. The present invention can effectively clean stubborn stains and dirt, thereby reducing the works required for cleaning and thus bringing much greater convenience to people's daily lives.

### BRIEF DESCRIPTION OF THE DRAWINGS

For better illustrations of the embodiment of the present invention or the prior arts, drawings required to illustrate the embodiment or the prior arts are briefly described below. Obviously, the figures described below only illustrate one embodiment of the present invention. A person skilled in this field of art may obtain other figures based on the figures disclosed below provided that no inventive effort is required.

FIG. 1 is a structural view of a steam cleaner for grill oven according to the present invention.

FIG. 2 is a structural view of a brush of the steam cleaner for grill oven according to the present invention.

References in the figures: 1—body; 2—cleaner head; 3—connector; 4—nozzle; 5—brush; 51—connecting rods; 52—fixing rods; 53—supporting rods; 6—hand-held portion.

### DETAILED DESCRIPTION OF THE INVENTION

For better understanding of the present invention, the present invention will be clearly and thoroughly described below with reference to an embodiment. However, it should be understood that the embodiment that will be described is only one of the possible embodiments of the present invention but not the only embodiment of the present invention. All other embodiments obtainable without any inventive effort by a person skilled in this field of art based on the embodiment of the present invention disclosed below should also fall within the scope of protection of the present invention.

### Embodiment 1

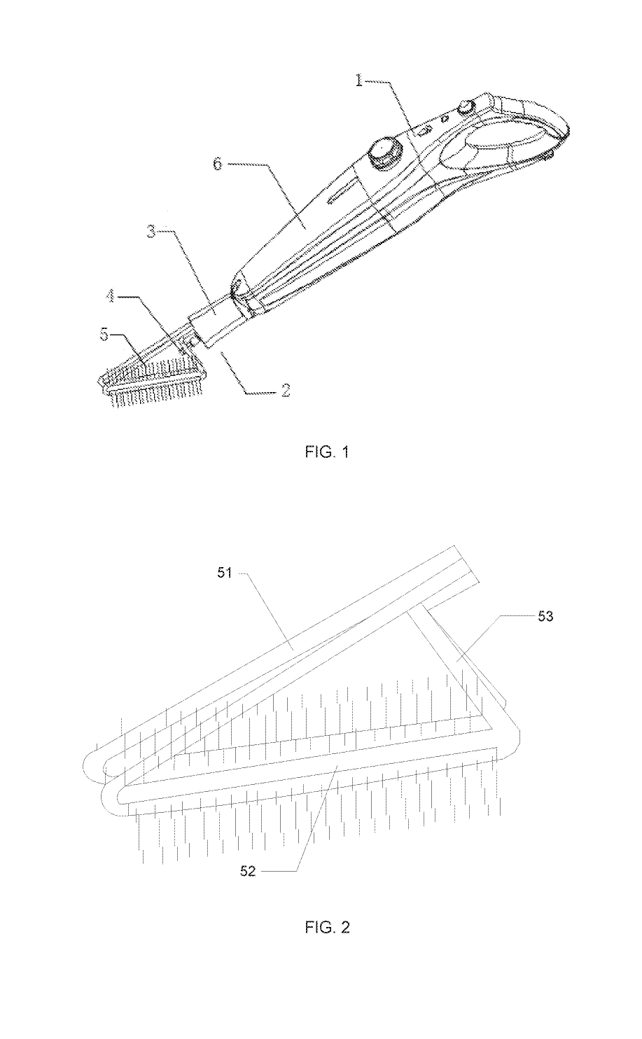

As shown in FIGS. 1-2, a steam cleaner for grill oven comprises a body 1, a steam generator disposed inside the body 1, and a cleaner head 2 connected with the body 1, wherein the cleaner head 2 comprises a connector 3, a nozzle 4 and a brush 5; the connector 3 enables quick replacement of different kinds of brushes. The cleaner head 2 is connected with the body 1 through the connector 3. The nozzle 4 and the brush 5 are mounted on the connector 3. The nozzle 4 is connected to the steam generator. Steam generated by the steam generator is ejected through the nozzle 4. The nozzle 4 is positioned above the brush 5. The steam ejected through the nozzle 4 flows to the brush 5 where the steam is condensed into water which is used for cleaning surfaces of a grill oven.

The brush 5 and the connector 3 are connected via insertion; specifically, the brush 5 is inserted into the connector The brush 5 is a wire brush planted with steel wires on its brush surface or a wire ball brush which is a steel wire ball used for household cleaning or a high-performance fiber brush. Removable connection between the brush 5 and the connector 3 facilitates quick replacement of the brush 5 at any time so that different kinds of brushes can be used for the grill rack of the grill oven according to different stubborn stains and dirt.

The brush 5 comprises a pair of connecting rods 51, a pair of fixing rods 52 and a pair of supporting rods 53 mutually connected with one another Top ends of the connecting rods 51 are connected with the connector 3. The nozzle 4 passes through between the supporting rods 53 and situates above the fixing rods 52. The fixing rods 52 are located at a bottom end of the brush. The fixing rods 52 are provided with steel wires, or steel wire ball for household cleaning, or high-performance fibers.

A hand-held portion 6 is provided on the body 1. When using the steam cleaner to clean the grill oven, the hand-held portion 6 is held by a user's hand. A hand-held steam cleaner is shorter and lighter than a steam mop, and is therefore more suitable for cleaning the grill oven which is usually mounted above the ground by a certain distance.

The embodiment described above is only a preferred embodiment of the present invention and should not be considered limiting the present invention. Any changes, modifications or alternative configurations that achieve equivalent effects made within the essence and principle of the present invention should fall within the scope of protection of the present invention.

What is claimed is:

1. A steam cleaner for grill oven, comprising a body, a steam generator disposed inside the body, and a cleaner head connected with the body, wherein the cleaner head comprises a connector, a nozzle and a brush; the cleaner head is connected with the body through the connector; the nozzle and the brush are mounted on the connector; the nozzle is connected to the steam generator; steam generated by the steam generator is ejected through the nozzle; the nozzle is positioned above the brush; the steam ejected through the nozzle flows to the brush where the steam is condensed into water which is used for cleaning surfaces of the grill oven.

2. The steam cleaner for grill oven according to claim 1, wherein the brush and the connector are removably connected to facilitate quick replacement of the brush by other kinds of brushes.

3. The steam cleaner for grill oven according to claim 1, wherein the brush and the connector are connected via insertion, wherein the brush is inserted into the connector.

4. The steam cleaner for grill oven according to claim 1, wherein the brush is a wire brush planted with steel wires on a brush surface thereof, or a wire ball brush which is a steel wire ball used for household cleaning, or a high-performance fiber brush.

5. The steam cleaner for grill oven according to claim 1, wherein the brush comprises a pair of connecting rods, a pair of fixing rods and a pair of supporting rods connected with one another; top ends of the connecting rods are connected with the connector; the nozzle passes through between the supporting rods and situates above the fixing rods; the fixing rods are located at a bottom end of the brush; the fixing rods are provided with steel wires, or steel wire ball for household cleaning, or high-performance fibers.

6. The steam cleaner for grill oven according to claim 1, wherein a hand-held portion is provided on the body; when using the steam cleaner to clean the grill oven, the hand-held portion is held by a user's hand.
